(19) United States
(12) Patent Application Publication
(10) Pub. No.: US 2013/0031106 A1
(43) Pub. Date: Jan. 31, 2013

(54) SOCIAL NETWORK POWERED QUERY SUGGESTIONS

(71) Applicants: Michael A. Schechter, Sammamish, WA (US); Mahbubul A. Ali, Redmond, WA (US); Brian D. Humrichouser, San Francisco, CA (US); Marek Latuskiewicz, Kirkland, WA (US); Yi Lang Mok, Bellevue, WA (US); Mihir A. Vaidya, Redmond, WA (US)

(72) Inventors: Michael A. Schechter, Sammamish, WA (US); Mahbubul A. Ali, Redmond, WA (US); Brian D. Humrichouser, San Francisco, CA (US); Marek Latuskiewicz, Kirkland, WA (US); Yi Lang Mok, Bellevue, WA (US); Mihir A. Vaidya, Redmond, WA (US)

(73) Assignee: MICROSOFT CORPORATION, Redmond, WA (US)

(21) Appl. No.: 13/311,869

(22) Filed: Dec. 6, 2011

Related U.S. Application Data
(60) Provisional application No. 61/513,157, filed on Jul. 29, 2011.

(51) Int. Cl. G06F 17/30

(52) U.S. Cl. 707/749; 707/769; 707/748; 707/E17.014; 707/E17.032

(57) ABSTRACT

Automatic suggestion for search query formulation is facilitated by considering social network information. A plurality of search queries can be identified as a function of a partial search query specified by a user and search history of one or more social network contacts of the user. Subsequently, these identified queries can be ranked to aid determination of a subset of the identified queries to suggest for query completion. Further, query suggestions resulting from a social network contact can be annotated to set them apart from other query suggestions.

### CROSS-REFERENCE TO RELATED APPLICATIONS

This application claims the benefit of U.S. Provisional Application No. 61/513,157, filed Jul. 29, 2011, and entitled “SOCIAL NETWORK POWERED QUERY SUGGESTIONS,” and is incorporated herein by reference in its entirety.

### BACKGROUND

A search engine is employed to maximize the likelihood of locating meaningful information amongst an abundance of data. Sets of data, such as World Wide Web (web) resources (e.g., webpage, image, recording . . . ) are analyzed and indexed automatically. Search queries can be specified by a user with or without the help of automatic completion, which suggests queries as the user inputs a query character by character in a search box, for example. Upon receipt of a query, a search engine utilizes a generated index to locate and return relevant search results expeditiously. The search results can subsequently be presented to a user in numerous ways. For example, a number of uniform resource locators (URLs), or links, can be returned identifying specific webpages that satisfy a query. Alternatively, a tiled set of thumbnails representing images can be presented as results of a search over an image database. To improve relevance of search results, a search engine can seek to employ additional context regarding a user such current geographic location.

Social networking services continue to be quite popular. A social network is a social structure made up of individuals or contacts connected by various types of relationships including friendship, kinship, business, and/or common interest, among other things. A social networking service is an online/web-based service that enables service users to establish social relationships with other users as well as share data of interest with some or all associated users. In this context, each user is represented by a profile that identifies various aspects of a user to other users, such as demographic information, a set of interests such as hobbies or professional skills, and a set of resources that are interesting to the users. Users may choose to share certain social data items with others including public or target messages, images, files, or references to interesting resources, such as a webpage. A user can also choose to draw attention to social data items shared by others, for example by reposting the data items in a news feed.

Social search involves employing a social networking service in combination with a search engine to allow results of an executed query to be tailored to a particular user. For example, a social networking profile can be utilized to influence results of a search query.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to social network powered query suggestion. Automatic query suggestion functionality is extended by including search history of social network contacts of a user as a source of potential query suggestions, for example to complete a partial query. Further, query suggestions can be ranked as a function of social-network contact behavior, among other things. Further yet, query suggestions resulting from the search history of social network contacts can be annotated in various ways to distinguish these query suggestions from those resulting from other sources.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a search system.

FIG. 2 is a block diagram of a representative query-suggestion component.

FIG. 3 is a flow chart diagram of a method of identifying user search activity.

FIG. 4 is a flow chart diagram of a method of query suggestion.

FIG. 5 is a flow chart diagram of a method of presenting query suggestions.

FIG. 6 is a schematic block diagram illustrating a suitable operating environment for aspects of the subject disclosure.

### DETAILED DESCRIPTION

Details below are generally directed toward social network powered query suggestions. When performing a search, query formulation is one of the most difficult problems for users to overcome in order to obtain quality search results. To assist users with this task, automatic suggestion, or completion, functionality is utilized. For example, search queries can be suggested to a search engine user incrementally as the user inputs a query character by character in a search box. Conventionally, search queries are suggested from a set of generic queries curated from aggregated, anonymous sources. Here, query suggestions are extended by including search history of social network contacts of a user within the set of potential query suggestions. Further, ranking of queries can be based on social-network contact behavior, among other things, and suggested queries resulting from a social network contact can be annotated to set them apart from other suggested queries.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

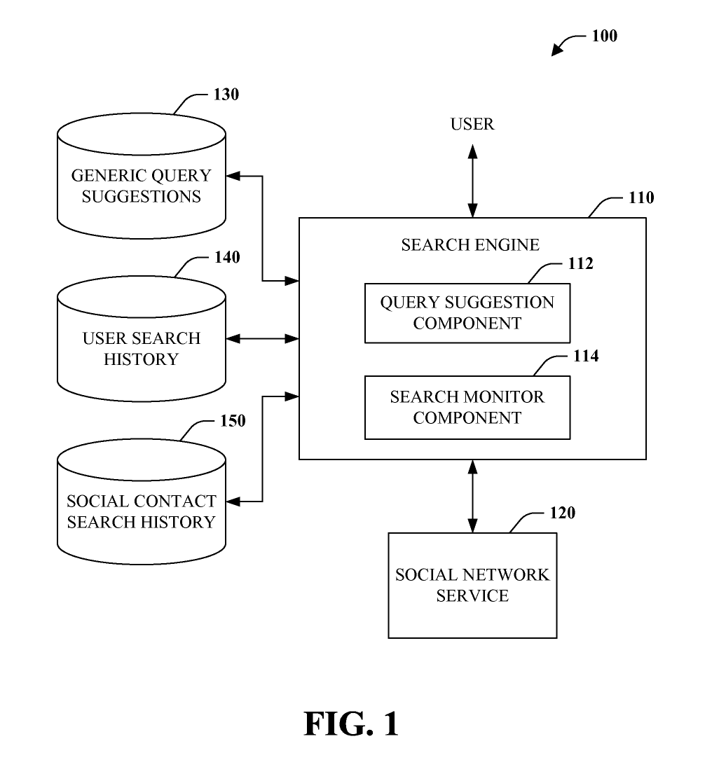

Referring initially to FIG. 1, a search system 100 is illustrated. The search system 100 includes search engine 110 communicatively coupled to social network service 120 and a plurality of sources of queries, namely generic query suggestions 130, user search history 140, and social-network contact search history 150.

The search engine 110 is generally configured to enable receipt of a search query from a user over a set of data and return of a set of search results. Search engine 110 can be designed for specific kinds of data sources. One prominent type of search engine 110 is a web search engine, which indexes a set of web resources, or content, such as websites with various web pages including text, images, audio, or video accessible by way of the Internet. Upon receipt of a search query from a user, a web search engine can identify webpages relevant to the search query and return a set of links on a search engine results page (SERP).

Furthermore, the search engine 110 provides pre-search query formulation assistance. More specifically, query suggestion component 112 is configured to afford automatic suggestion, or query completion, functionality. For example, search queries can be suggested to a search-engine user incrementally as the user inputs a query character by character in a search box. The query suggestion component 112 can identify queries for suggestion from various sources. For example, the query suggestion component 112 can identify queries from generic query suggestions 130 as is conventionally done. Generic query suggestions 130 include queries curated from aggregated, anonymous sources. In other words, generic query suggestions 130 correspond to what a majority of search-engine users input. Additionally or alternatively, generic query suggestions 130 could be programmed by human editors biased toward queries with better performance or results, among other things. Further, candidate queries for suggestion can be identified from user search history 140 and social-network contact search history 150. That is, queries can be identified for suggestion as a function of previous queries performed by a user or the user's friends, fans, followers, etc. (a.k.a. social contacts).

By way of example, consider a user who is looking for a good seafood restaurant in a city the user is visiting such as Seattle. If the user did not know anything about Seattle, the user would typically enter a search query for “seafood in Seattle,” and get back a bunch of links to restaurants some of which are good and some of which are bad. Now the user needs to research reviews of each restaurant. Essentially, this is a process dependent on the user's skill in searching, knowledge of a topic, and ability to enter appropriate search terms. However, the user may have friends, family, or other social contacts that live in Seattle or have visited Seattle before and done the same research. Without asking contacts, information can be automatically obtained as to how the contacts formed the same search, presented to the user, and utilized to drive query completion suggestions. Based on how a social contact performed a search, what the social contact saw, and what the contact did (together social signals) decisions can be made regarding what queries to suggest to complete a partial query.

Search monitor component 114 is configured to monitor queries input by users of the search engine 110. To facilitate monitoring, when a user utilizes the search engine 110 an identifier can be associated with them or their computer to distinguish the user from other users. This identifier can be randomly assigned or provided by authenticating to an identity providing service. In accordance with one embodiment, that identity providing service can be social network service 120, but is not limited thereto. Consequently, the identifier can be provided upon a user logging on to the social network service 120. As a user searches, the user's search history 140, including search queries entered as well as selected search results (e.g., clicked URLs), is stored against this identifier by the search monitor component 114. Of course, user can opt out or opt in to various aspects for privacy reasons. For example, a user may grant permission for search queries to be stored against an identifier but not share collected data with social contacts.

The social network service 120 is a collection of components that provide an online social network service that allows a user to create a social profile that represents and describes the user as well as establish associations representing various types of relationships with other users (e.g., family members, friendships, acquaintances, colleagues, fans . . . ). Further, the social network service 120 can enable exchange of information including demographic information (e.g., age, academic history, career history, interests . . . ), messages (e.g., personal messages directed to particular users, or user groups, chat messages delivered to particular users participating in a chat session, public comments that may be viewed by many users of the social network service . . . ), as well as other data (e.g., documents, images, music videos, files . . . ). In one instance, the social network service 120 can be embodied as a website that provisions the aforementioned and other functionality.

The search monitor component 114 can interact with the social network service 120 to acquire identifiers and other information regarding a particular user's social network contacts. The social network service 120 can maintain a social graph identifying social network contacts of users. Accordingly, the search monitor component 114 can request the social network contacts of a particular user or determine them from a provided social graph of a user's social network contacts. Searches performed by social network contacts can then be stored against corresponding identifiers as social-network contact search history 150 for use by the query suggestion component 112.

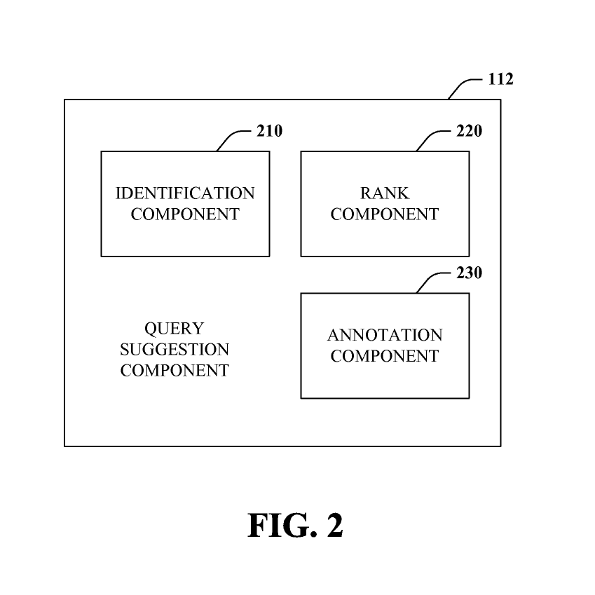

FIG. 2 depicts a representative query-suggestion component 112 in further detail including identification component 210, rank component 220, and annotation component 230. The identification component 210 is configured to identify candidate queries from amongst various sources that overlap with a portion of a query input by a user. The overlap can be lexical or conceptual. Lexical overlapping pertains to words that appear the same. For example, if the portion of the query includes the two characters “xb,” candidate queries can include “xbox” and “xbox games” since they both begin with “xb.” Conceptual overlapping refers to queries pertaining to the same or similar concept or context. In the previous example, conceptually overlapping queries can include “playstation” and “playstation games” since “Xbox” and “PlayStation” pertain to the same concept, namely video game systems. Furthermore, the identification component 210 can be continually refining overlapping candidate queries as a user continues to enter characters in a query, for example.

The rank component 220 is configured to rank, or weight, candidate queries identified by the identification component 210 to enable suggestion of a subset queries likely to be selected by a user, for example to complete a partially specified query. In accordance with one embodiment, social network information including behavior of social network contacts can be utilized in ranking candidate queries. For instance, ranking can be performed as a function of the number of social network contacts that performed a query, whether a particular social network contact selected (e.g., clicked) a search result produced by query execution, the number of selections contacts have made on search results, how many contacts selected a search result produced from the query, the number of contacts that selected a suggested query, closeness of a contact, and/or relative expertise of a contact, among other things. By way of example, if a user communicates frequently with social network contacts “X” and “Y” but not as much with contact “Z,” the rank component 220 can assign a greater rank score, or weight, to queries performed by “X” and “Y” than to “Z.” Of course, other ranking algorithms can be employed by the rank component 220 as well such as, but not limited to, similarity of a candidate query to a complete or partial user query.

The annotation component 230 is configured to identify in some way query suggestions that resulted from a social network or more specifically social network contacts. Such suggested queries can thus be set apart from other queries that the general public may be provided, for example, and authority added to suggested queries based on social-network contacts. Examples of annotation provided by annotation component 230 include but are not limited to one or more social-network contact pictures or names, the name of the social network, or other markings.

The query suggestion component 112 can be configured to operate in a customized manner for a user. In one instance, a user can identify specific social network contacts to include or exclude from query suggestion or weight more or less. For example, the user can identify a subset of contacts, such as work colleagues, to employ with respect to suggestion of all or particular types of queries. Overall, any signal (positive or negative, coarse or fine grained . . . ) can be specified by a user to govern query suggestion.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the query suggestion component 112 can utilize such mechanisms to rank candidate queries for suggestion.

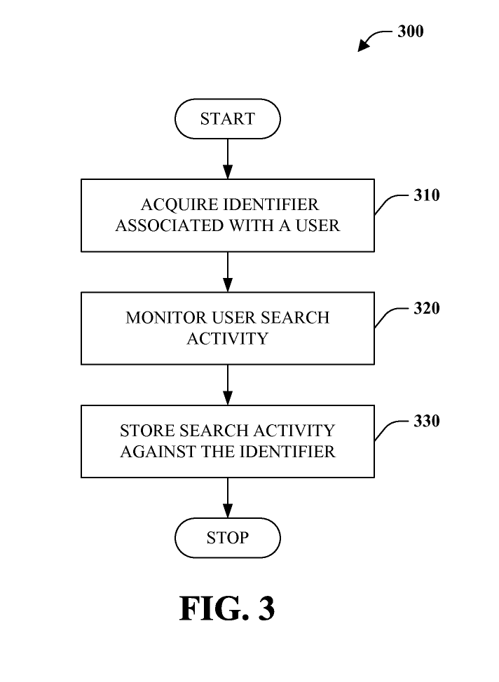

In view of the exemplary systems described supra, methodologies that may be implemented in accordance with the disclosed subject matter will be better appreciated with reference to the flow charts of FIGS. 3-5. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 3, a method 300 of identifying user search activity is depicted. At reference numeral 310, an identifier is acquired that is associated with a particular user. According to one embodiment, the identifier can be obtained from a social network or other service upon authenticating with the service (e.g., providing user name and passcode). At numeral 320, a user's search activity is monitored or otherwise observed. Search activity can include, among other things, search queries submitted for execution and selection of results with respect to particular queries. At reference 330, the observed search activity is stored against the identifier associated with a user.

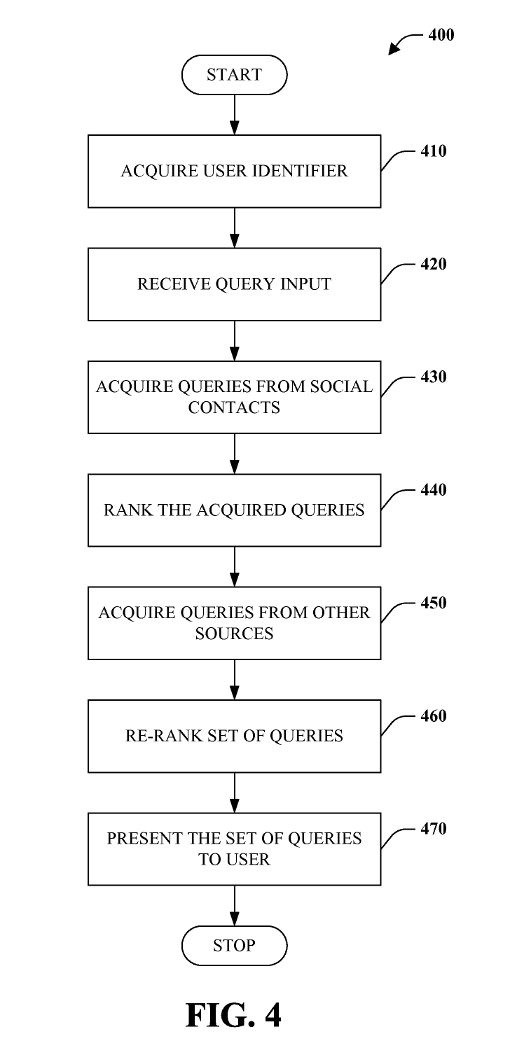

FIG. 4 illustrates a method 400 of query suggestion. At reference numeral 410, an identifier is acquired that is associated with a user or particular user computer. Such an identifier can be obtained directly from the user or indirectly via authentication with a search engine and/or social network service, for example. At numeral 420, query input is received such as a partial search query, or in other words a portion of a complete search query, for instance as typed by a user in a search box. At reference numeral 430, queries made by social network contacts of the user that overlap lexically or conceptually with the partial search query are acquired. These queries are called candidate queries, as they are candidates for suggestion. At numeral 440, the candidate queries are ranked, for example as a function of social network contact behavior, among other things. At reference, 450 candidate queries can be acquired from other sources including the user's search history (e.g., including annotations made by the user such as favorites, tags, notes . . . ), a generic suggestion set, and/or algorithmically generated suggestions based on query context, among others. At numeral 460, candidate queries acquired from all sources are ranked. At reference numeral 470, a subset of the queries is selected based on rank and presented to the user.

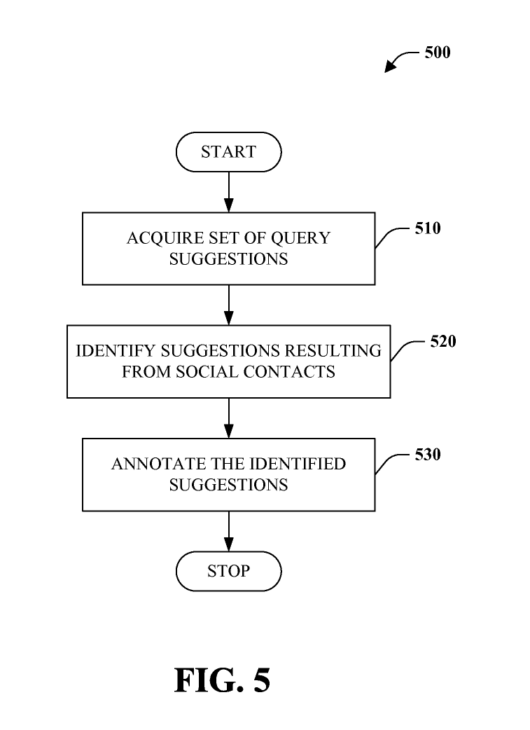

FIG. 5 is a flow chart diagram of a method 500 of presenting query suggestions is depicted. At reference numeral 510, a set of query suggestions is received, retrieved, or otherwise obtained or acquired. At numeral 520, query suggestions resulting from social network contacts are identified. At reference numeral 530, the identified query suggestions are annotated to distinguish query suggestions that resulted from social network contacts from other query suggestions. For example, such query suggestions can be annotated with pictures, text, or other markings. In one instance, pictures of one or more social-network contacts that performed a suggested query are injected next to the query.

Aspects of the disclosed subject matter have been described within the context of a single social network service for purposes of clarity and understanding. Of course, aspects of the disclosure are also applicable to multiple social network services as well. For example, query suggestions could be ranked based on social contacts from a general social network service (e.g., Facebook) and a business and professional network service (e.g., LinkedIn). Furthermore, ranks can vary by network. For instance, for example if it can be determined or inferred that a search concerns business or professional content, searches performed by contacts from a professional and business network and be weighted more heavily than those from a general social network. Further yet, query suggestions can optionally be annotated with information indicating from which of several social networks a suggestion was produced.

As used herein, the terms “component,” “system,” and “engine” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

The conjunction “or” as used this description and appended claims in is intended to mean an inclusive “or” rather than an exclusive “or,” unless otherwise specified or clear from context. In other words, “X or Y” is intended to mean any inclusive permutations of “X” and “Y.” For example, if “A employs X,” “A employs Y,” or “A employs both A and B,” then “A employs X or Y” is satisfied under any of the foregoing instances.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

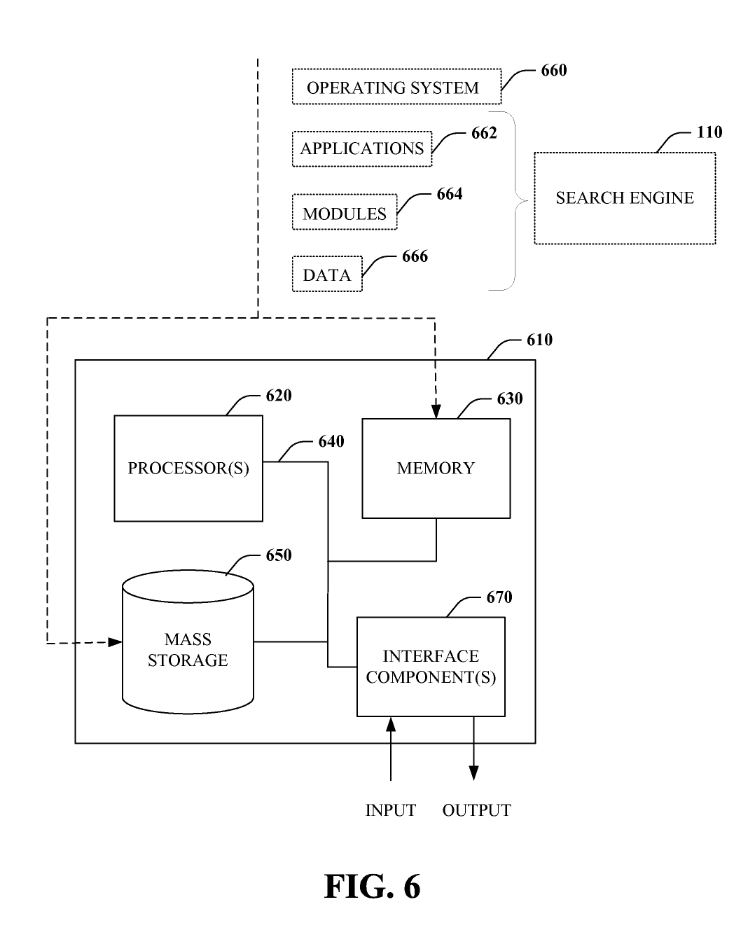

In order to provide a context for the claimed subject matter, FIG. 6 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 6, illustrated is an example general-purpose computer 610 or computing device (e.g., desktop, laptop, server, hand-held, programmable consumer or industrial electronics, set-top box, game system . . . ). The computer 610 includes one or more processor(s) 620, memory 630, system bus 640, mass storage 650, and one or more interface components 670. The system bus 640 communicatively couples at least the above system components. However, it is to be appreciated that in its simplest form the computer 610 can include one or more processors 620 coupled to memory 630 that execute various computer executable actions, instructions, and or components stored in memory 630.

The processor(s) 620 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 620 may also be implemented as a combination of computing devices, for example a combination of a DSP and a microprocessor, a plurality of microprocessors, multi-core processors, one or more microprocessors in conjunction with a DSP core, or any other such configuration.

The computer 610 can include or otherwise interact with a variety of computer-readable media to facilitate control of the computer 610 to implement one or more aspects of the claimed subject matter. The computer-readable media can be any available media that can be accessed by the computer 610 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 610.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 630 and mass storage 650 are examples of computer-readable storage media. Depending on the exact configuration and type of computing device, memory 630 may be volatile (e.g., RAM), non-volatile (e.g., ROM, flash memory . . . ) or some combination of the two. By way of example, the basic input/output system (BIOS), including basic routines to transfer information between elements within the computer 610, such as during start-up, can be stored in nonvolatile memory, while volatile memory can act as external cache memory to facilitate processing by the processor(s) 620, among other things.

Mass storage 650 includes removable/non-removable, volatile/non-volatile computer storage media for storage of large amounts of data relative to the memory 630. For example, mass storage 650 includes, but is not limited to, one or more devices such as a magnetic or optical disk drive, floppy disk drive, flash memory, solid-state drive, or memory stick.

Memory 630 and mass storage 650 can include, or have stored therein, operating system 660, one or more applications 662, one or more program modules 664, and data 666. The operating system 660 acts to control and allocate resources of the computer 610. Applications 662 include one or both of system and application software and can exploit management of resources by the operating system 660 through program modules 664 and data 666 stored in memory 630 and/or mass storage 650 to perform one or more actions. Accordingly, applications 662 can turn a general-purpose computer 610 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the search engine 110, or portions thereof, can be, or form part, of an application 662, and include one or more modules 664 and data 666 stored in memory 630 and/or mass storage 650 whose functionality can be realized when executed by one or more processor(s) 620.

In accordance with one particular embodiment, the processor(s) 620 can correspond to a system on a chip (SOC) or like architecture including, or in other words integrating, both hardware and software on a single integrated circuit substrate. Here, the processor(s) 620 can include one or more processors as well as memory at least similar to processor(s) 620 and memory 630, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the search engine 110 and/or associated functionality can be embedded within hardware in a SOC architecture.

The computer 610 also includes one or more interface components 670 that are communicatively coupled to the system bus 640 and facilitate interaction with the computer 610. By way of example, the interface component 670 can be a port (e.g., serial, parallel, PCMCIA, USB, FireWire . . . ) or an interface card (e.g., sound, video . . . ) or the like. In one example implementation, the interface component 670 can be embodied as a user input/output interface to enable a user to enter commands and information into the computer 610 through one or more input devices (e.g., pointing device such as a mouse, trackball, stylus, touch pad, keyboard, microphone, joystick, game pad, satellite dish, scanner, camera, other computer . . . ). In another example implementation, the interface component 670 can be embodied as an output peripheral interface to supply output to displays (e.g., CRT, LCD, plasma . . . ), speakers, printers, and/or other computers, among other things. Still further yet, the interface component 670 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of facilitating search, comprising:
employing at least one processor configured to execute computer-executable instructions stored in memory to perform the following acts:
identifying one or more search queries as a function of a partial search query specified by a user, prior to initiating execution of a search, and search activity of one or more social contacts of the user.

2. The method of claim 1 further comprises ranking the one or more search queries based on whether a social contact selected a search result provided as a result of execution of a corresponding one of the one or more search queries.

3. The method of claim 1 further comprises ranking the one or more search queries based on a number of social contacts that selected a search result produced as a function of a particular suggested search query.

4. The method of claim 1 further comprises ranking the one or more search queries as a function of closeness of social contacts.

5. The method of claim 1 further comprises ranking the one or more search queries as a function of expertise of the one or more social contacts.

6. The method of claim 1 further comprises annotating the one or more queries with information that identifies social contacts that performed the one or more queries.

7. The method of claim 6 further comprises annotating the one or more search queries with pictures that identify the social contacts.

8. The method of claim 1 further comprises identifying the one or more search queries as a function of user search history.

9. The method of claim 1 further comprises identifying the search queries as a function of query context.

10. A system that facilitates search, comprising:
a processor coupled to a memory, the processor configured to execute the following computer-executable components stored in the memory:
a first component configured to identify a plurality of suggested queries as a function of a portion of a query specified by a user, prior initiating search execution, and queries performed by one or more social network contacts of the user.

11. The system of claim 10 further comprises a second component configured to rank the suggested queries based on behavior of the social network contacts with respect to the queries performed thereby.

12. The system of claim 11 further comprises a third component configured to annotate the suggested queries performed by the one or more social network contacts.

13. The system of claim 12, the third component is configured to annotated at least one of the suggested queries with a picture of one or more the social network contacts that performed a respective query.

14. The system of claim 10 further comprises a second component configured to record search interactions of a plurality of users.

15. The system of claim 10, the first component is configured to identify the plurality of suggested queries as a function of an identified subset of the social network contacts.

16. The system of claim 10 the first component identifies the suggested queries as a function of search history of the user.

17. A computer-readable storage medium having instructions stored thereon that enables at least one processor to perform the following acts:
identifying at least one search query submitted by at least one social network contact of a search engine user as a function of a partial search query specified by the user prior to initiation of a search with a complete search query.

18. The computer-readable storage medium of claim 17 further comprises communicating the at least one search query to the user.

19. The computer-readable storage medium of claim 18 further comprises annotating the at least one search query with information identifying the social contact.

20. The computer-readable storage medium of claim 17 further comprises ranking the at least one search query as a function of behavior of the at least one social contact.
